(19) United States
(12) Patent Application Publication
(10) Pub. No.: US 2024/0010167 A1
(43) Pub. Date: Jan. 11, 2024

(54) PANE WIPER

(71) Applicant: Lior ANAVI, Jerusalem (IL)

(72) Inventor: Lior ANAVI, Jerusalem (IL)

(21) Appl. No.: 18/208,959

(22) Filed: Jun. 13, 2023

(30) Foreign Application Priority Data
Jul. 11, 2022 (IL) 294667

(51) Int. Cl. B60S 1/38

(52) U.S. Cl. CPC B60S 1/3874; B60S 2001/3837

(57) ABSTRACT

A pane wiper, including: an elastic elongated arm including a holder for holding and moving the elastic elongated arm, and an elongated casting including first and second elongated wiping elements, the elongated casting being connected to the elastic elongated arm.

### CROSS-REFERENCE TO RELATED APPLICATIONS

This application claims the benefit of priority from Israel Patent Application No. 294667, filed Jul. 11, 2022, the disclosure of which is incorporated herein by reference.

### TECHNICAL FIELD

The invention relates to the field of wipers, and more particularly to vehicle windscreen wipers.

### BACKGROUND

FIG. 1 depicts a prior art vehicle pane wiper.

A prior art vehicle pane wiper includes a first rigid arm 12 being pivotally connected to a second rigid arm 16A.

FIG. 2 depicts the prior art vehicle pane wiper of FIG. 1 without the first rigid arm.

Second rigid arm 16A is pivotally connected to springy leaves 18A and 18B.

Springy leaf 18A is pivotally connected to wiper fasteners 20A1 and 20A2; and springy leaf 18B is pivotally connected to wiper fasteners 20B1 and 20B2.

A wiper 42C is fastened by fasteners 20A1, 20A2, 20B1 and 20B2. Thus, pressing of rigid arm 16A, springily presses wiping element 42C through leaves 18A and 18B.

However, wiper 42C alone does not efficiently rub dirt, and as well is cumbersome.

There is a long felt need to provide a solution to the above-mentioned and other problems of the prior art.

### SUMMARY

A pane wiper, including:
an elastic elongated arm; and
an elongated casting including wiping elements.

### BRIEF DESCRIPTION OF THE DRAWINGS

Embodiments, features, and aspects of the invention are described herein in conjunction with the following drawings:

FIG. 1 depicts a prior art vehicle pane wiper.

FIG. 2 depicts the prior art vehicle pane wiper of FIG. 1 without the first rigid arm.

FIG. 3 is a top perspective view of a vehicle pane wiper according to one embodiment of the invention.

FIG. 4 is a bottom perspective view of the vehicle pane wiper of FIG. 3.

FIG. 5 is a side sectional view of the vehicle pane wiper of FIG. 3.

FIG. 6 is a perspective view of the springy leaf of FIG. 5.

FIG. 7 is the side sectional view of the windscreen of FIG. 4 and the pane wiper of FIG. 5 upon moving in relation to the windscreen.

FIG. 8 is a side sectional view of the vehicle pane wiper of FIG. 3 according to another embodiment.

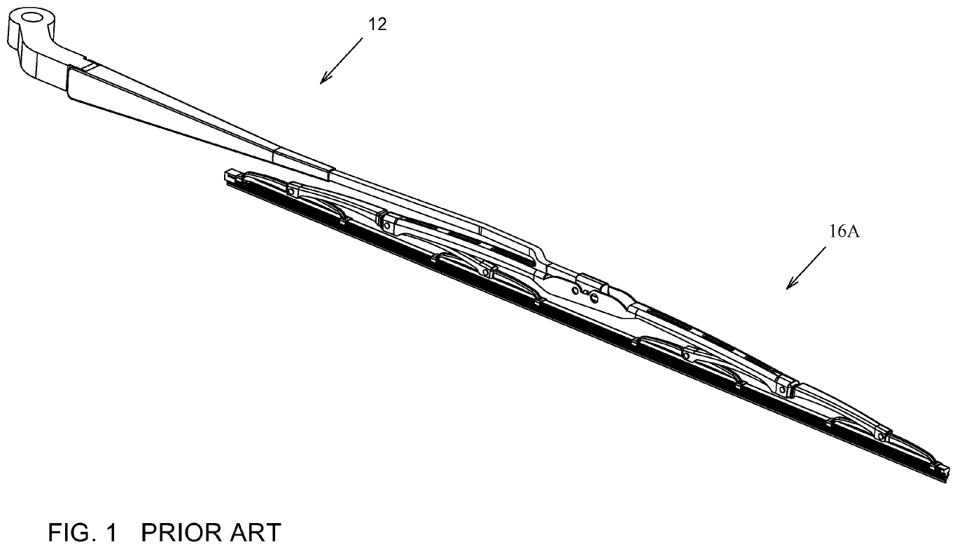

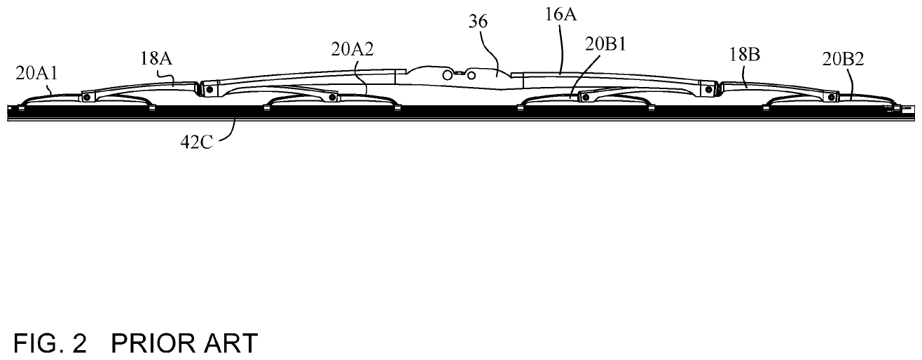

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

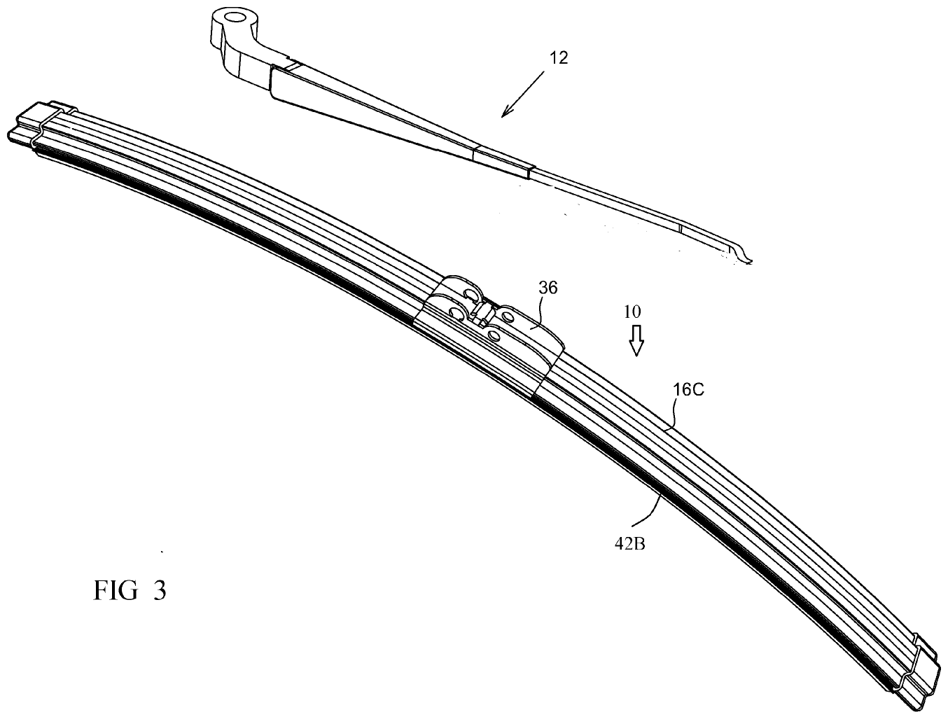

FIG. 3 is a top perspective view of a vehicle pane wiper according to one embodiment of the invention.

A vehicle pane wiper 10 according to one embodiment of the invention an elastic arm 16C including an arm holder 36, for holding a rigid arm 12, extending from the vehicle (not shown).

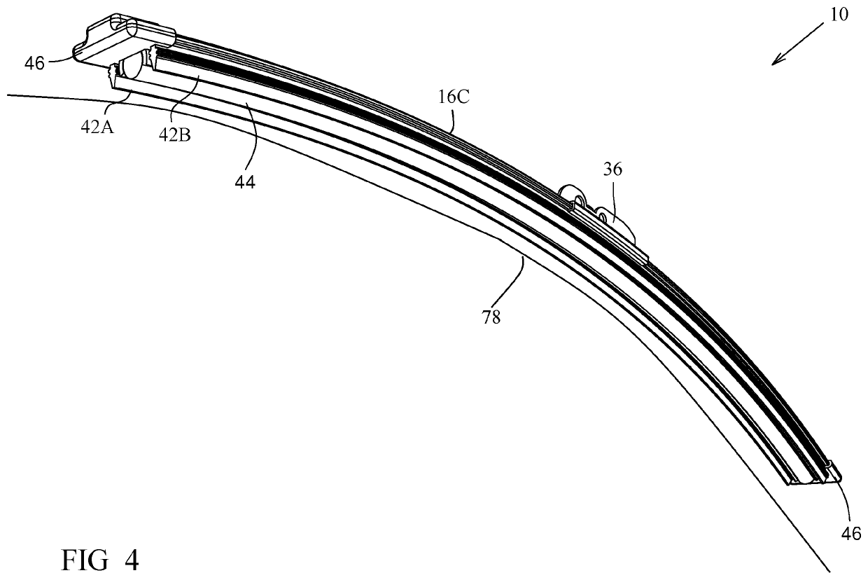

FIG. 4 is a bottom perspective view of the vehicle pane wiper of FIG. 3.

Elongated elastic arm 16C holds elongated wiping elements 42A and 42B, and a cylinder 44 disposed therebetween such that cylinder 44 is rotatable (72).

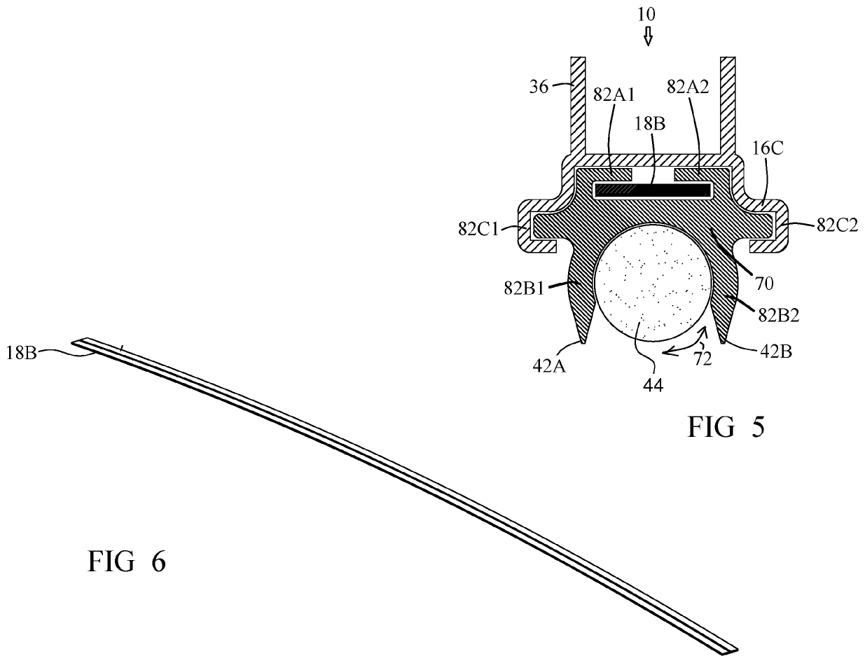

FIG. 5 is a side sectional view of the vehicle pane wiper of FIG. 3.

Elongated elastic arm 16C is shaped such that it includes a short arm holder 36, and it embraces an elongated casting 70, shaped to include elongated wiping elements 42A and 42B.

Elongated casting 70 includes top arms 82A1 and 82A2 for embracing an elongated springy leaf 18B thereabove; and further includes elongated rounded arms 82B1 and 82B2 for elastically embracing rotatable (72) cylinder 44.

FIG. 6 is a perspective view of the springy leaf of FIG. 5.

Springy leaf 18B maintains the arced shape shown in FIG. 4 of each of wiping elements 42A and 42B being the arc shape of the vehicle windscreen/pane 78 for attaching each of wiping elements 42A and 42B to windscreen 78.

FIG. 7 is the side sectional view of the windscreen of FIG. 4 and the pane wiper of FIG. 5 upon moving in relation to the windscreen.

Pane wiper 10 is shown moving at direction 54 in relation to windscreen 78, thus wiping element 42B wipes dirt 58 towards elongated cylinder 44, and elongated cylinder 44 rotates (72) to wipe dirt 58 towards wiping element 42B, thus dirt 58 might undesirably insert into therebetween.

Cylinder 44 preferably is coarse for rubbing dirt 58 while being rotated (72).

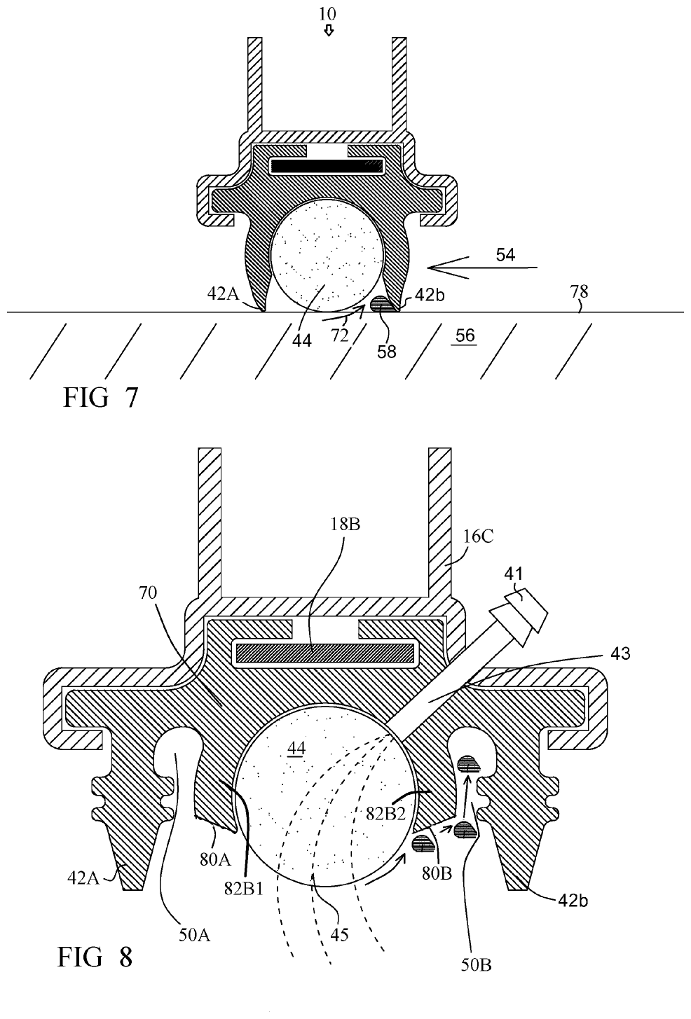

FIG. 8 is a side sectional view of the vehicle pane wiper of FIG. 3 according to another embodiment.

Elongated casting 70 may further include an elongated gap 50A disposed between wiping element 42A and arm 82B1 embracing cylinder 44; and an elongated gap 50B disposed between wiping element 42B and arm 82B2 embracing cylinder 44. Thus the dirt enters gaps 50A and 50B being channels for removing the dirt.

Cylinder 44 supports and avoids bending of wiping elements 42A and 42B, thus allowing producing gentle wiping elements.

Arm 82B1 may include a tilt 80A for directing the dirt towards 50A.

Cylinder 44 may include nozzles 41 for splashing water 45.

Thus, in one aspect, the invention is directed to a pane wiper (10), including:
an elastic elongated arm (16C) including a holder (36) for holding and moving the elastic elongated arm (16C);
an elongated casting (70) including first (42A) and second (42B) elongated wiping elements, the elongated casting (70) being connected to the elastic elongated arm (16C).

The pane wiper (10) may further include:
an elongated springy leaf (18B) being connected to the elongated casting (70), for providing thereof springiness.

The pane wiper (10) may further include:
an elongated cylinder (44) being rotatably (72) held by the elongated elastic arm (16C) between the first (42A) and second (42B) elongated wiping elements.

The elongated casting (70) may include elongated rounded arms (82B1,82B2) for elastically embracing the elongated cylinder (44)

The elastic elongated arm (16C) may include embracing arms (82C1,82C2) for elastically embracing the elongated casting (70).

The elongated casting (70) may include elongated arms (82A1,82A2) for elastically embracing the elongated springy leaf (18B).

The elongated casting (70) may includes at least one elongated gap (50A) disposed between the first (42A) and second (42B) wiping elements.

The at least one elongated gap (50A) may include one elongated gap disposed adjacent to each the first (42A) and second (42B) wiping elements.

In the figures and description herein, the following reference numerals (Reference Signs List) have been mentioned:
numeral 10 denotes the pane wiper according to one embodiment of the invention;
12: rigid arm extending from the vehicle;
16A: rigid arm of the prior art vehicle pane wiper;
16C: elastic arm of pane wiper 10, preferably of plastic, polymer or the like;
18A,18B: springy leaves, preferably of metal;
20A1,20A2,20B1,20B2: wiper fasteners;
36: arm holder;
41: water nozzle;
42A,42B,42C: elongated wiping elements;
43: water pipe supplying water to water nozzle 41;
44: elongated rotatable cylinder;
45: water;
46: cover;
54: wiping direction;
70: casting, preferably of plastic, polymer or the like;
72: rotation of cylinder 44;
78: windscreen/pane of the vehicle;
80A,80B: tilts of elongated rounded arms 82B1 and 82B2 respectively;
82A1,82A2, 82B1,82B2, 82C1,82C2: embracing arms;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A pane wiper, comprising:
an elastic elongated arm comprising a holder for holding and moving said elastic elongated arm; and
an elongated casting comprising first and second elongated wiping elements, said elongated casting being connected to said elastic elongated arm.

2. The pane wiper according to claim 1, further comprising:
an elongated springy leaf being connected to said elongated casting, for providing thereof springiness.

3. The pane wiper according to claim 1, further comprising:
an elongated cylinder being held by said elongated elastic arm between said first and second elongated wiping elements.

4. The pane wiper according to claim 3, wherein said elongated casting comprises elongated rounded arms for elastically embracing said elongated cylinder, and for allowing rotation of said elongated cylinder in relation to said elongated casting.

5. The pane wiper according to claim 1, wherein said elastic elongated arm comprises embracing arms for elastically embracing said elongated casting.

6. The pane wiper according to claim 2, wherein said elongated casting comprises elongated arms for elastically embracing said elongated springy leaf.

7. The pane wiper according to claim 1, wherein said elongated casting comprises at least one elongated gap (50A) disposed between said first and second wiping elements.

8. The pane wiper according to claim 7, wherein said at least one elongated gap (50A) comprises one elongated gap disposed adjacent to each said first and second wiping elements.
